(19) United States
(12) Patent Application Publication
(10) Pub. No.: US 2023/0324249 A1
(43) Pub. Date: Oct. 12, 2023

(54) SENSOR DEVICE FOR DETECTING A LEAKAGE

(71) Applicant: emz-Hanauer GmbH & Co. KGaA, Nabburg (DE)

(72) Inventors: Georg SPIESSL, Altendorf (DE); Manfredi SIGNORINO, Wackersdorf (DE); Christian MEIER, Guteneck (DE); Johann KLEBER, Nabburg (DE)

(73) Assignee: emz-Hanauer GmbH & Co. KGaA, Nabburg (DE)

(21) Appl. No.: 18/297,458

(22) Filed: Apr. 7, 2023

(30) Foreign Application Priority Data
Apr. 12, 2022 (DE) 10 2022 108 949.5
Nov. 25, 2022 (DE) 10 2022 131 271.2

(51) Int. Cl. G01M 3/18

(52) U.S. Cl. CPC G01M 3/186

(57) ABSTRACT

The invention relates to a sensor device for detecting a leakage, in particular for a water-bearing household appliance, the sensor device comprising a base device and a detector device, the detector device being arranged on the base device by means of at least one first releasable non-positive and/or positive connection, the detector device detecting a change in an electrical parameter in a measuring chamber or a measuring element of the base device, the detector device having a first housing which can be closed in a sealed manner and in which a self-sufficient power supply device and a circuit arrangement are arranged, the circuit arrangement comprising a communication device.

### CROSS REFERENCE TO RELATED APPLICATIONS

This application claims the benefit of German Patent Application No. 10 2022 108 949.5, filed Apr. 12, 2022, and German Patent Application No. 10 2022 131 271.2, filed Nov. 25, 2022, the entire contents of which are incorporated herein by reference in their entireties.

### FIELD

The invention relates to a sensor device for detecting a leakage, in particular in a water-bearing household appliance. Furthermore, the invention comprises a system comprising a water-bearing household appliance and a sensor device.

### BACKGROUND

Such water-bearing household appliances can be, for example, dishwashers or washing machines. Such household appliances include a container device, which is also referred to as a lye container, in which the objects to be washed and the washing liquid are located.

Furthermore, the household appliances include at least one water inlet and one outlet. In some regions, it is common to have two water inlets, namely a cold water inlet and a hot water inlet. In other regions, however, it is also common to use only one water inlet. Usually, a hose or pipe is provided to connect the corresponding connections in the building to the connections of the household appliance. However, both the connections and the corresponding hose or pipe can leak. The water-bearing components in the household appliance itself may also have leaks. Such leaks can cause unwanted leakages, which in turn often cause considerable damage.

### SUMMARY

There is thus a need to inform a user immediately after the occurrence of a leakage so that he can eliminate the causes as soon as possible. The user would also like to receive information regarding the location of the leakage upon such an occurrence.

The object of the present invention is to provide a sensor device for detecting a leakage for a water-bearing household appliance, which overcomes the disadvantages mentioned at the beginning. It is also an object of the invention to provide a system comprising a water-bearing household appliance and a sensor device.

The object is solved by the subject matters of claims 1 and 11. The dependent claims comprise preferred embodiments.

According to the invention, a sensor device for detecting a leakage, in particular for a water-bearing household appliance, is provided, wherein the sensor device comprises a base device and a detector device, wherein the detector device is arranged on the base device by means of at least one first releasable non-positive and/or positive connection, the detector device detecting a change in an electrical parameter in a measuring chamber and/or a measuring element of the base device, the detector device having a first housing which can be closed in a sealed manner and in which a self-sufficient power supply device and a circuit arrangement are arranged, the circuit arrangement comprising a communication device.

A self-sufficient power supply device is a power supply device that does not have a permanent connection to the power grid. Such a self-sufficient power supply device could be, for example, a battery or a similar current or voltage storage device. A power supply device based on photovoltaics or other power generation would also be conceivable. The aforementioned removal of the detector device from the base device also enables maintenance of the power supply device, for example in the form of battery replacement.

Such a sensor device according to the invention can be used extremely flexibly due to its self-sufficient power supply and its communication device and can do without a fixed wired power supply. Preferably, the sensor device also does not require any wired communication transmission. The sensor device can be arranged on or near water-bearing parts, such as hoses or pipes, the connections on the household appliance or the building, or even below the household appliance.

The base device comprises a measuring chamber or a measuring element. However, it is also conceivable that the base device only comprises a measuring element. A liquid can leak, for example, from a leaking building connection, a leaking connection of the household appliance, a connecting hose, a connecting pipe or from the household appliance itself. This leaked liquid, for example leakage water, alkaline water, etc., enters or is in the measuring chamber or is in contact with the measuring element. The presence of this liquid influences the electrical parameter measured by the sensor device. The change in this electrical parameter is detected by the sensor device or the detection device of the sensor device. Such a change can then be transmitted immediately after detection by means of the transmitter device to a corresponding appliance, for example to the household appliance. Advantageously, the communication device is suitable and intended for establishing and/or operating a wireless communication link with the appliance, for example the household appliance. However, it is also conceivable that the communication device is suitable and intended for establishing and/or operating a wireless communication connection with another user device. Such other user device could be a smartphone, a tablet, a personal computer or the like. Preferably, the wireless communication link is a Bluetooth® link, a Bluetooth® low energy link, an RFID (radio-frequency identification) link, an NFC (near field communication) link, a WLAN link, a cellular link or a combination of the aforementioned links. The communication device advantageously comprises a transmitter device or a transmitter and receiver device.

According to a further advantageous embodiment, the first housing of the detector device extends along a height axis Z, a width axis X, and a longitudinal axis Y. Advantageously, the first housing is made of a plastic. Advantageously, the first housing is manufactured by means of an injection moulding process. Preferably, the first housing of the detector device comprises a first housing element which has, at least in sections, a polygonal, in particular an octagonal, base surface. Advantageously, a first side wall with side faces of the first housing element oriented in accordance with the base surface extends along the height axis Z. In the advantageous case that the sensor device is arranged in a receiving element, these side faces provide contact surfaces for the receiving device. The polygonal, in particular octagonal, design facilitates insertion into the receiving element.

Advantageously, a first side wall with side faces of the first housing element oriented according to the base extends along the height axis Z. In the advantageous case that the sensor device is arranged in a receiving element, these side faces provide contact surfaces for the receiving device. The polygonal, in particular octagonal, design facilitates insertion into the receiving element.

Advantageously, a carrier device with two opposite sides is arranged in the first housing element. Advantageously, the carrier device is a printed circuit board (PCB) or similar. Preferably, the self-sufficient power supply device is arranged on a first side of the carrier device. Furthermore, it is advantageous that the circuit arrangement is predominantly arranged on a second side of the carrier device. By predominantly arranged it is to be understood that a predominant number of the components belonging to the circuit arrangement are arranged on the second side of the carrier device. Accordingly, it would be possible that some components are arranged on the first side. Preferably, the circuit arrangement is arranged entirely on the second side of the carrier device. Preferably, the first and second sides of the carrier device are opposite.

According to a further advantageous embodiment, the first housing of the detector device comprises a second housing element which is arranged on the first housing element by means of a second non-positive and/or positive connection. Such a non-positive and/or positive connection could, for example, be a snap connection, a screw connection or the like. It is advantageous if furthermore a sealing element is provided between the first and the second housing element. Advantageously, the second housing element is arranged along the height axis Z above the first housing element on the latter. Preferably, the second housing element comprises a substantially circular base surface.

According to a preferred embodiment, the first housing element and the second housing element comprise an opening mechanism for easier release of the second non-positive and/or positive connection. Advantageously, the first housing element comprises at least one web element extending along the height axis Z. Preferably, the first housing element comprises two web elements extending along the height axis Z. Advantageously, the second housing element comprises at least one chamfered elevation. Preferably, the second housing element comprises two chamfered elevations. Preferably, the at least one protrusion extends along the peripheral direction. Preferably, an extension of the elevation along the height axis Z increases in the course along the peripheral direction. Advantageously, during a rotational movement of the second housing element relative to the first housing element, the at least one chamfered elevation abuts the at least one web element. Preferably, during a rotational movement of the second housing element relative to the first housing element, the at least one chamfered elevation slides along the at least one web element, whereby the second housing element is pressed away from the first housing element along the height axis Z. This makes it particularly easy to release the second non-positive and/or positive connection between the first housing element and the second housing element. This is necessary, for example, for maintenance activities, such as changing the power supply device in the form of a battery.

According to a further advantageous embodiment, the electrical parameter is an electrical resistance and/or an electrical capacitance. Advantageously, the detector device for detecting the electrical parameter comprises at least two sensing elements. Preferably, these sensing elements are at least electrically connected to the circuit arrangement. Advantageously, the at least two sensing elements are each mechanically and electrically connected to the carrier device and thus to the circuit arrangement by means of a spring element.

The circuit arrangement preferably comprises a measuring and comparison device which measures the electrical parameter and detects a change in this electrical parameter. Advantageously, the measuring and comparison device is electrically connected to the at least two sensing elements.

According to a further advantageous embodiment, two first non-positive and/or positive connections are provided between the base device and the detector device. Advantageously, these first non-positive and/or positive connections are snap connections. Preferably, these first non-positive and/or positive connections each comprise a head element and a receiving element. It is advantageous that the head element is detachably fixed in the respective receiving element in the manner of a push button. Advantageously, the head elements are arranged on the detector device and the receiving elements on the base device or vice versa. Advantageously, the sensing elements are integrated in the head elements or the receiving elements. Preferably, the head elements and the receiving elements consist of an electrically conductive material, so that the first positive connection between a respective head element and the corresponding receiving element also creates an electrically conductive connection between the head element and the receiving element.

According to a further advantageous embodiment, the base device comprises a second housing. Preferably, the receiving elements or the head elements are arranged on the second housing. Advantageously, the second housing is made of a plastic. Advantageously, the second housing is manufactured by means of an injection moulding process.

According to one embodiment, the head elements of the two first non-positive and/or positive connections are arranged on the first housing of the detector device. Preferably, the head elements are integrated in the first housing of the detector device. Advantageously, the two sensing elements are each integrated in a head element. The respective receiving elements would thus be arranged on the second housing of the base device. Preferably, the receiving elements are integrated in the second housing of the base device.

According to a further embodiment, the head elements of the two first non-positive and/or positive connections are arranged on the second housing of the base device. Preferably, the head elements are integrated in the second housing of the base device. The respective receiving elements would thus be arranged on the first housing of the detector device. Preferably, the receiving elements are integrated in the first housing of the detector device. Advantageously, the two sensing elements are each integrated in a receiving element.

By dividing the sensor device into a base device and a detector device and connecting them by means of a detachable first non-positive and/or positive connection, the detector device can be removed from the base device in a simple manner. The detector device houses the complex components of the sensor device, which also require maintenance. The detector device can therefore be removed from the base device for maintenance purposes, for example. The base device can thus remain in position, whereby the mounting of the base device can remain unchanged.

According to a further aspect of the invention, it is advantageous in that the measuring element is a belt element or a clamping element. Advantageously, the belt element or the clamping element serves as a first fastening means for the sensor device to a water-bearing element, for example a hose, a pipe or a connection. Advantageously, the belt element or the clamping element is arranged on the second housing and serves to fasten the second housing to the water-bearing element. Accordingly, the base device advantageously comprises the second housing and the measuring element in the form of a belt element or a clamping element. The measuring element is thus advantageously both a fastening means and a passive element on which, or with the aid of which, the measurement of the electrical parameter is carried out. Preferably, the belt element or the clamping element is arranged on the second housing.

According to a further advantageous embodiment, the base device comprises only the measuring element. The measuring element is advantageously a belt element or a clamping element. The first non-positive and/or positive connection is advantageously made via a socket of the belt element on the first housing of the detector device and lashing of the belt element to a corresponding component.

According to a further embodiment, the belt element consists of a textile material which has a lower conductivity than the conducting tracks. Advantageously, the textile material is suitable for absorbing liquid. Preferably, the belt element comprises fastening sections by means of which a hook and loop connection can be created. The belt element can thus be attached to a component, for example a tube, a hose, a connector or another element, by means of a hook and loop fastener.

Advantageously, the belt element or the clamping element comprises at least two conducting tracks along their longitudinal extension. Preferably, the conducting tracks extend along the entire longitudinal extension of the belt element or the clamping element. However, it would also be conceivable for them to extend only in sections along the longitudinal extension. Advantageously, the electrical parameter is given between the at least two conducting tracks. Accordingly, the electrical parameter between the at least two conducting tracks is monitored.

According to a further embodiment, a standard element is connected between the conducting tracks, which specifies a standard value of the electrical parameter. According to a further embodiment, a standard element is connected between the receiving elements which specifies a standard value of the electrical parameter. Preferably, the standard element is a resistance element and the standard value is a resistance value. By measuring such a standard value, the at least one first non-positive and/or positive connection can be checked. The conducting tracks are each electrically connected to a receiving element. The connection of the standard element between the conducting tracks or between the receiving elements thus produces the same result. If the first non-positive and/or positive connection did not exist or existed only partially, the specified resistance value could either not be measured at all or a falsified value would be measured. Thus, an error message could be sent via the communication device indicating a faulty first connection. The resistance element can preferably be an electrical component. As already explained, the belt element may be made of a first textile material. Advantageously, the resistance element is formed as an electrically conductive second textile material in the belt element, which is introduced as a section in the first textile material of the belt element. The conductivity of the second textile material differs from the conductivity of the first textile material. The second textile material thus has the functionality of an electrical component arranged between the conducting tracks.

According to a further preferred embodiment, the base device comprises a receiving element which spatially delimits the measuring chamber at least in sections and is suitable for and intended to receive the detector device. Preferably, the receiving element is arranged on a first section of a liquid collecting device which can be arranged on an underside of a household appliance. Preferably, the receiving element comprises two arm elements which enclose the detector device in sections and hold it by means of a third non-positive and/or positive connection. Advantageously, the arm elements rest against the first side walls or its side faces of the first housing element.

According to a further preferred embodiment, the first section of the one liquid collecting device is plate-like. The measuring chamber is thus advantageously delimited by the plate-like liquid collecting device, the first housing element of the first housing and the two arm elements of the receiving element. The two advantageous sensing elements preferably project into the measuring chamber. If liquid now escapes from the household appliance, this is collected by the liquid collecting device and then directed into the measuring chamber through an opening between the two arm elements. The presence of the liquid in the measuring chamber affects the electrical parameter between the two sensing elements. This change is detected by the measuring and comparison device. When such a change is detected, a corresponding indication is sent via the communication direction.

According to a further aspect of the invention, the receiving element is arranged at a front end of the first section of the liquid collecting device along the longitudinal direction Y′. In this aspect, it is advantageous that the liquid collecting device has a slope along the longitudinal direction Y′ towards the front end or towards the receiving element. This effectively guides the escaping liquid to the receiving element so that even a small amount of liquid can be detected.

According to a further embodiment, the base device comprises a receiving element which is arranged on a liquid collecting device. Preferably, at least two conducting tracks are arranged on or in the liquid collecting device. Preferably, one conducting track is electrically connected to each sensing element. Preferably, the electrical parameter is given between the at least two conducting tracks. The advantageous measuring element is thus a liquid collecting device with the conducting tracks. Cumulatively, a measurement of the electrical parameter can also be provided in the measuring chamber.

According to a further embodiment, the circuit arrangement comprises a monitoring device which monitors the charge state of the power supply device in the form of a battery. In the event of a drop below a predetermined limit value, a corresponding indication can thus be sent by the communication device.

The present problem of the invention is also solved by a sensor device for detecting a leakage, in particular for a water-bearing household appliance, the sensor device comprising a base device and a detector device, the detector device being arranged on the base device by means of at least one first releasable non-positive and/or positive connection, the detector device detecting a change in an electrical parameter in a measuring element of the base device, the detector device having a first housing which can be closed in a sealing manner and in which a self-sufficient power supply device and a circuit arrangement are arranged, a standard element being provided which predetermines a standard value of the electrical parameter, the standard element being a resistance element, it being possible to check the at least one first non-positive and/or positive connection by measuring this standard value.

This sensor device can be equipped with all the features of the embodiments already described above, either individually or in combination with each other, and vice versa.

The standard element can be connected between the conducting tracks of the measuring element or between the receiving elements of the base device. Preferably, the standard element is a resistance element and the standard value is a resistance value. By measuring such a standard value, the at least one first non-positive and/or positive connection can be checked. The conducting tracks are each electrically connected to a receiving element. The connection of the standard element between the conducting tracks or between the receiving elements thus produces the same result. If the first non-positive and/or positive connection did not exist or existed only partially, the specified resistance value could either not be measured at all or a falsified value would be measured. Thus, an error message could be sent via the communication device indicating a faulty first connection. The resistance element can preferably be an electrical component. As already explained, the belt element can be made of a first textile material. Advantageously, an electrically conductive second textile material is formed as the resistance element in the belt element, which is introduced as a section in the first textile material of the belt element. The conductivity of the second textile material differs from the conductivity of the first textile material. The second textile material thus has the functionality of an electrical component arranged between the conducting tracks.

The present object of the invention is also solved by a household appliance comprising at least one sensor device according to one of the previously described embodiments. The household appliance can be equipped with all the features described above in the context of the sensor device, either individually or in combination with one another, and vice versa.

Such a household appliance may advantageously be a dishwasher, washing machine, or other water-bearing household appliance. Both a dishwasher and a washing machine comprise a container device as well as a lye container. The items to be washed are placed in this tub. During the washing process, a washing liquid in the form of water mixed with a treatment agent is then introduced into the lye container. Such household appliances include at least one water inlet and outlet. In some regions, it is common for two water inlets to be provided, in the form of a cold water inlet and a warm water inlet. Often, however, only one water inlet is used. A hose or pipe is usually provided to connect the appropriate connections in the building to the connections of the household appliance.

The present object of the invention is also solved by a system comprising a water-bearing household appliance and at least one sensor device according to one of the preceding embodiments. The system can be equipped with all the features already described above in the context of the sensor device or the household appliance, either individually or in combination with one another, and vice versa.

According to a preferred embodiment, the household appliance comprises at least one (water) inlet and at least one (waste water) outlet, wherein at least one sensor device is attached to the inlet and/or the outlet by means of the first fastening means. Advantageously, the first fastening means is the measuring element in the form of a belt element or a clamping element.

According to a further preferred embodiment, a liquid collecting device is arranged on an underside of the household appliance, the liquid collecting device comprising a central first section which can be displaced forwards in a drawer-like manner relative to the two outer second sections along a longitudinal direction. As already described, the receiving device with a sensor device is advantageously arranged at a front end of the central first section along the longitudinal axis Y′.

According to a further preferred embodiment, at least the central first section of the liquid collecting device is arranged on the household appliance such that it has a forward slope along the longitudinal direction Y′ of the household appliance. Advantageously, at least one receiving element with a detector device is arranged at a front end of the central first section along the longitudinal direction Y′. Accordingly, the liquid collecting device or at least the central first section of the liquid collecting device is arranged in such a way that it has a slope running along the longitudinal direction Y′, so that the liquid emerging from the household appliance is effectively directed to the receiving device or the measuring chamber of the sensor device. It is also conceivable that the liquid collecting device comprises guiding elements, for example protrusions, funnel elements or the like, to guide the liquid to the sensor device. It is also conceivable that several receiving devices, each with a detector device, are provided on the liquid collecting device.

According to another aspect of the invention, the household appliance comprises a second communication device which communicates with the communication device of the at least one sensor device. Upon receiving a corresponding communication regarding a leakage, the household appliance may output an indication by means of a display device. Such an indication device may be, for example, a display, a lighting device or a sound output. Alternatively or cumulatively, an indication may be sent to an external user device by means of the second communication device. An external user device may be, for example, a smartphone, a tablet computer, a laptop or similar device.

Advantageously, the indication sent by the communication device of the sensor device comprises an identification message. If the system includes several sensor devices, the receiver, for example the household appliance, can identify which sensor device has sent the indication of a leakage. The user can then be informed of the exact location of the leakage.

Further advantages, objectives and features of the present invention are explained with reference to the following descriptions of the accompanying figures. Similar components may have the same reference signs in the various embodiments.

### BRIEF DESCRIPTION OF THE DRAWINGS

Show in the figures:

FIG. 1 a perspective view of a sensor device according to one embodiment;

FIG. 2 a schematic sketch of the circuit arrangement;

FIG. 3 a perspective view of a sensor device according to one embodiment with an opened first housing;

FIG. 4 a perspective view of a sensor device according to one embodiment with an opened first housing;

FIG. 5 a sectional view of a sensor device according to one embodiment;

FIG. 6 a sectional view of a sensor device according to one embodiment;

FIG. 7 a perspective view of a sensor device according to one embodiment;

FIG. 8 a perspective view of a sensor device according to one embodiment, wherein the detector device is separate from the base device;

FIG. 8a a perspective view of a sensor device according to one embodiment, wherein only the base device is shown;

FIG. 8b a perspective view of a sensor device according to one embodiment, wherein only the base device is shown;

FIG. 9 a perspective view of a sensor device according to one embodiment, wherein the detector device is separate from the base device;

FIG. 10 a perspective view of a sensor device according to one embodiment, which is arranged on an element;

FIG. 11 a sectional view of a sensor device according to one embodiment, which is arranged on an element;

FIG. 12 a sectional view of a sensor device according to one embodiment;

FIG. 13 a perspective view of a measuring element;

FIG. 14 a perspective view of a measuring element;

FIG. 15 a section of a measuring element;

FIG. 16 a perspective view of a liquid collecting device;

FIG. 17 a section of a liquid collecting device;

FIG. 18 a top view of a liquid collecting device;

FIG. 19 a section of a liquid collecting device;

FIG. 20 a section of a household appliance;

FIG. 21 a household appliance with a liquid collecting device;

FIG. 22 a top view of a liquid collecting device with conducting tracks.

### DETAILED DESCRIPTION

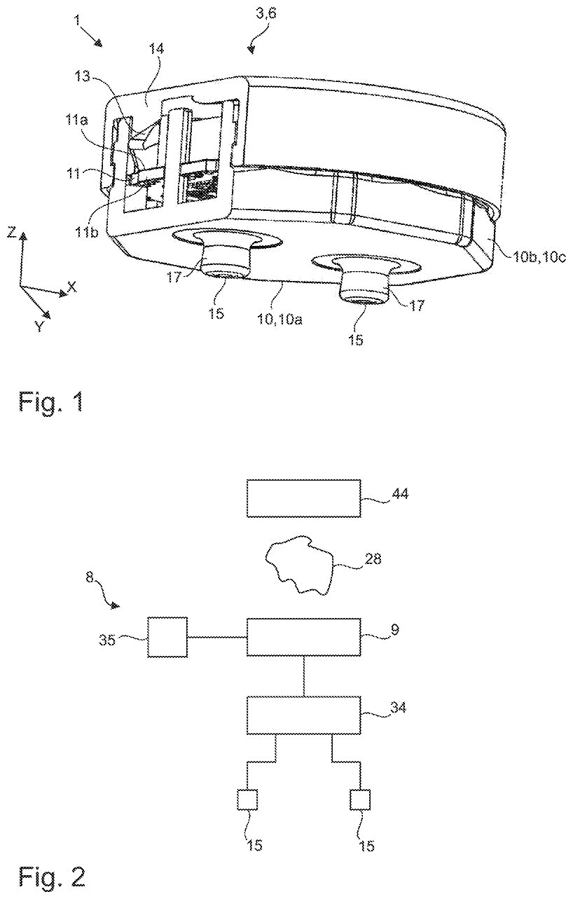

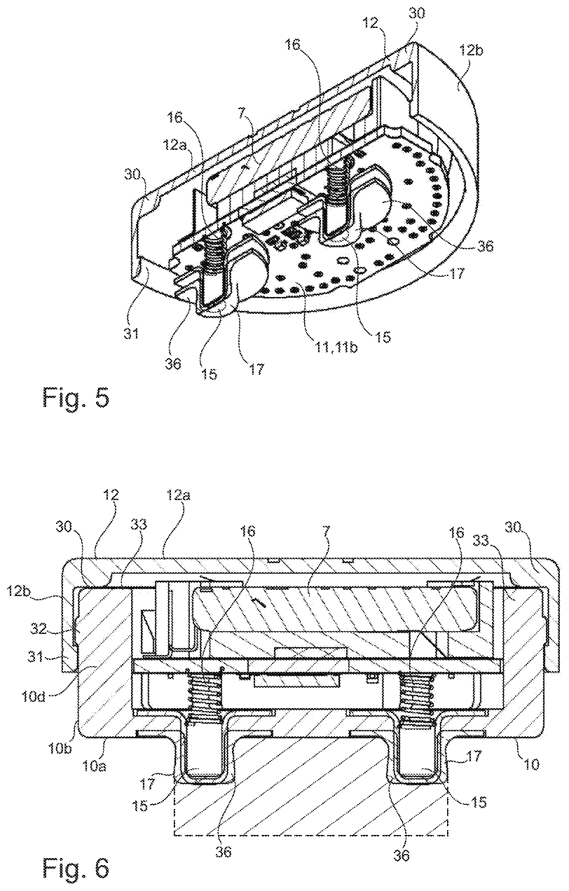

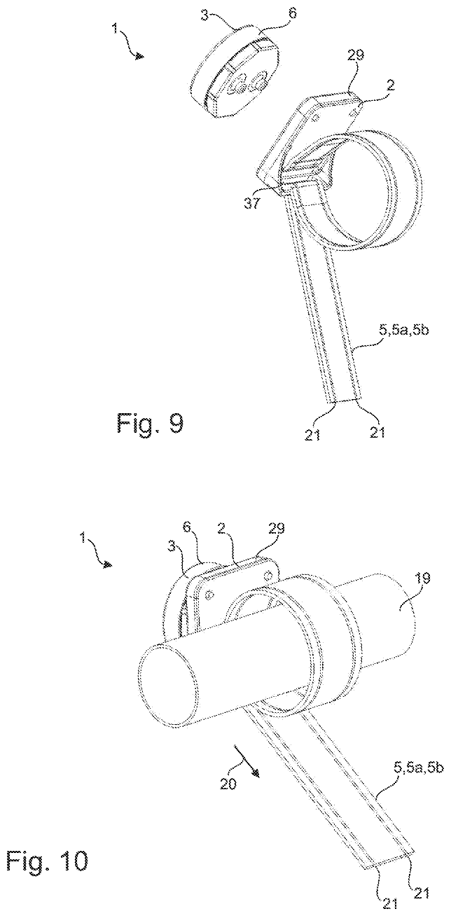

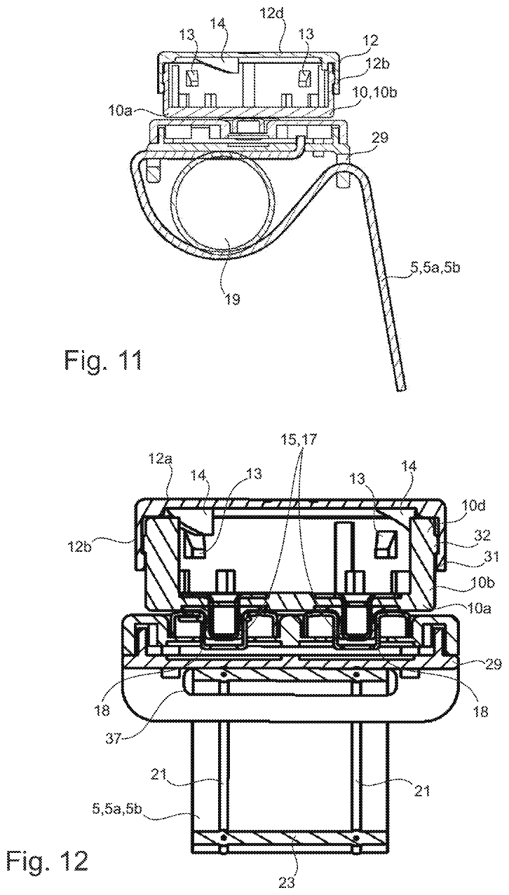

FIGS. 1 to 12, 18, 19 and 21 show a sensor device 1 for detecting a leakage, in particular for a water-bearing household appliance 100, the sensor device 1 comprising a base device 2 and a detector device 3, the detector device 3 being arranged on the base device 2 by means of at least one first releasable non-positive and/or positive connection, the detector device 3 detecting a change in an electrical parameter in a measuring chamber 4 and/or a measuring element 5 of the base device 2, the detector device 3 having a first housing 6 which can be closed in a sealed manner and in which a self-sufficient power supply device 7 and a circuit arrangement 8 are arranged, the circuit arrangement 8 comprising a communication device 9.

According to the figures shown, the base device 2 comprises a second housing 29. However, it is also conceivable that the base device 2 does not comprise a second housing 29 and only comprises a measuring element 5 in the form of a belt element 5a.

The household appliance 100 extends along a height axis Z′, a width axis X′ and a longitudinal axis Y′. The sensor device 1 for leakage detection for a water-bearing household appliance 100 extends along a height axis Z, a width axis X and a longitudinal axis Y. Accordingly, the first housing 6 and the second housing 29 extend along the height axis Z, the width axis X and the longitudinal axis Y.

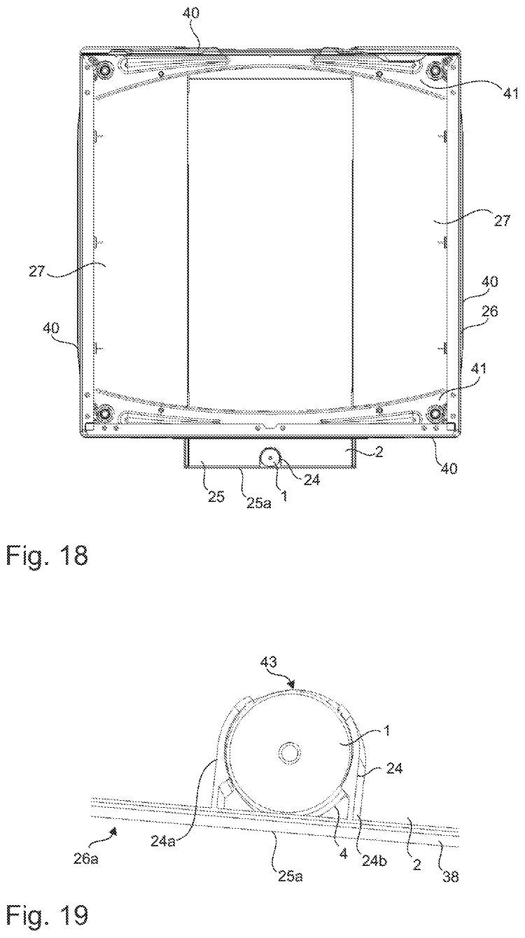

The first housing 6 of the detector device 3 comprises a first housing element 10 which has, at least in sections, a polygonal, in particular an octagonal base surface. The first housing element 10 comprises a plate-like base wall 10a, which is polygonal, in particular octagonal. Starting from the base wall 10a, a first side wall 10b extends along the height axis Z, which has side faces 10c, which in turn are aligned in accordance with the base surface. The side faces 10c thus extend in a polygonal shape, in particular an octagonal shape, corresponding to the base surface. This configuration facilitates the insertion and retention of the detector device 3 in a receiving element 24, as shown in FIGS. 18, 19 and 21. The first side wall 10b merges into a second side wall 10d, which is circular in shape. Furthermore, the first housing 6 of the detector device 3 comprises a second housing element 12. The second housing element 12 has a circular plate-like base wall 12a, from which a third side wall 12b extends along the height axis Z. The second housing element 12 is thus circular in shape. The second housing element 12 is thus of lid-like design.

The second housing element 12 is arranged along the height axis Z on the first housing element 10 by means of a second non-positive and/or positive connection. In a closed state of the detector device 3, the third side wall 12b of the second housing element 12 encloses the second side wall 10d of the first housing element 10. The second non-positive and/or positive connection is a snap connection. For this purpose, at least one annular circumferential protrusion 31 is arranged on an inner surface of the third side wall 12b. On an outer surface of the second side wall 10d there is also at least one annular protrusion 32. The two annular protrusions 31, 32 can be continuous or have interruptions or gaps. If the second housing element 12 is pressed onto the first housing element 10, the third side wall 12b deforms elastically, causing the protrusion 31 to slide or “snap” over the other protrusion 32. FIG. 6 further shows that a further annular protrusion 30 is provided on an inner surface of the base wall 12b of the second housing element 12. In a closed state of the detector device 3, this protrusion 30 rests against an upper edge 33 of the second side wall 10d. A sealing closure of the first housing 6 is thus made possible. Optionally, further sealing elements may be provided between the first housing element 10 and the second housing element 12.

To facilitate the disengagement of the second non-positive and/or positive connection, the first housing element 10 and the second housing element 12 comprise an opening mechanism. For this purpose, at least one, preferably two, web element(s) 13 extending along the height axis Z is provided in the first housing element 10. Furthermore, at least one, preferably two, chamfered elevation(s) 14 is provided on an inner surface of the base wall 12a of the second housing element 12. The at least one protrusion 14 extends along a peripheral direction U. Thereby, the extension of the at least one protrusion 14 along the height axis Z increases with the course along the peripheral direction U. During a rotational movement of the second housing element 12 relative to the first housing element 10, the at least one chamfered elevation 14 slides along the at least one web element 13. Due to the increasing height of the projection 14 along the peripheral direction U, the second housing element 12 is pressed away from the first housing element 10 along the height axis Z, whereby the second non-positive and/or positive connection is then released.

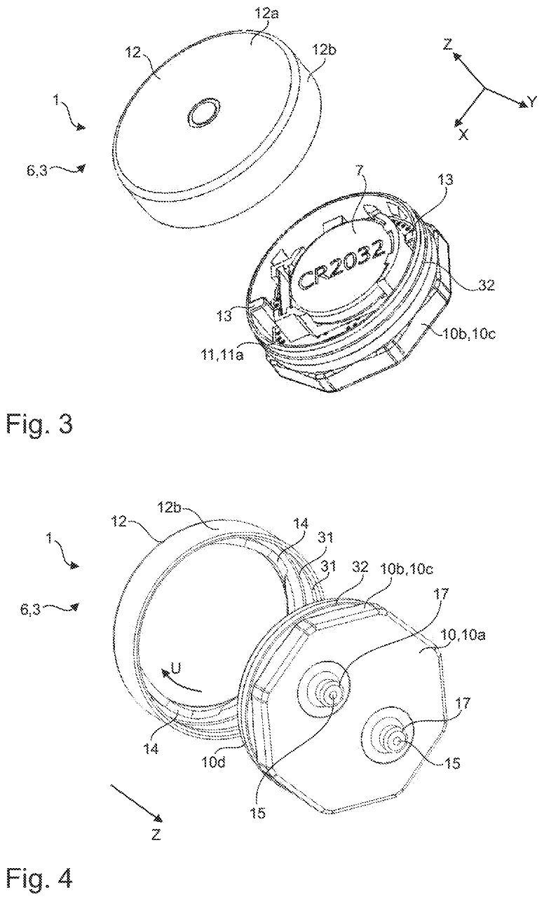

A carrier device 11 with two opposite sides is arranged, preferably fixed, in the first housing element 10. The carrier device 11 is designed in the form of a board or PCB (printed circuit board). The self-sufficient power supply device 7 is arranged on a first side 11a, which is directed towards the second housing element 12. The circuit arrangement 8 is predominantly arranged on or on the second side 11b of the carrier device 11. The two-sided assembly of the circuit board has the advantage that the detector device 3 can be built much more compactly. The power supply device 7 is described below as a battery. Of course, the present invention is not limited to this embodiment. In FIG. 3 it can be seen that the battery 7 is held in a holder. The battery 7 is replaceable if required. The orientation of the first side 11a with the battery 7 towards the second housing element 12 has the advantage that if the first housing 6 is opened, the battery 7 is easily accessible and replaceable.

The circuit arrangement 8 may comprise the communication device 9 and a measuring and comparison device 34. FIG. 2 shows a schematic sketch of some possible components of the circuit arrangement. It is also conceivable that a control device is provided which controls the components. Of course, other components are also conceivable. FIG. 2 also shows a monitoring device 35 for monitoring the charge level of the battery 7. This can inform the user that it is necessary to change the battery 7. The communication device 9 is suitable and intended for establishing and/or operating a wireless communication link 28 with the household appliance 100 or with a second communication device 27 of the household appliance 100. However, it would also be conceivable for a wireless communication link 28 to be established and/or operated with another communication device, for example a smartphone, a computer, etc. The wireless communication link 28 may be a Bluetooth® link, a Bluetooth® low energy link, an RFID (radio-frequency identification) link, an NFC (near field communication) link, a WLAN link, a mobile phone link, or a combination of said links.

The measured electrical parameter can be an electrical resistance and/or an electrical capacity. In the following, only the case that the electrical parameter is an electrical resistance will be discussed without limitation to the generality. The detector device 3 comprises at least two sensing elements 15 for detecting the electrical parameter. The sensing elements 15 are electrically connected to the circuit arrangement 8 or the measuring and comparison device 34. The sensing elements 15 protrude from the base wall 10a of the first housing element 10 and are spaced apart from each other. In the sectional views in FIGS. 6 and 12, it can be seen that a sensing element 15 is integrated in a head element 17 in each case. The head element 17 comprises a first cup-like element 36 which is integrated into the base wall 10a. This could be done, for example, by overmoulding in an injection moulding process. By integrating the cup-like element 36 or the head element 17 in this way, the first housing 6 is sealed against the penetration of a liquid. The cup-like element 36 or the head element 17 consist of an electrically conductive material, for example a metal. The cup-like element 36 has the sensing element 15 inserted into it or firmly connected to it. The cup-like element 36 can have an opening at its front end along the height axis Z, in which the sensing element 15 is arranged in a sealing manner. The at least two sensing elements 15 are each mechanically and electrically connected to the carrier device 11 by means of a spring element 16. Due to the tensioning by the spring elements 16, a particularly good electrical contact of the sensing elements 15 with the carrier device 11 or the circuit arrangement 8 is ensured. Furthermore, the mechanical pressure of the sensing elements 15 against the cup-like elements 36 generated by the spring elements 16 results in an improved electrical contact between these elements as well as a sealing of the opening in the cup-like elements 36.

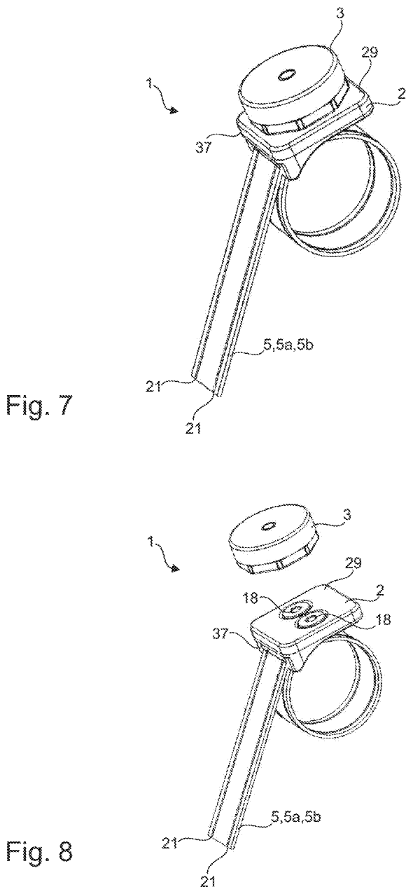

According to one embodiment, which is shown in FIGS. 7 to 15, two first non-positive and/or positive connections are provided between the base device 2 and the detector device 3. These first non-positive and/or positive connections are designed as snap connections, in particular as push-button connections, and each comprise a head element 17 and a receiving element 18. The head element 17 can be detachably fixed in the respective receiving element 18 in the manner of a push-button. For this purpose, the head element 17 has a circumferential thickening or a diameter decreasing along the height axis Z in the direction of the first housing 6. The thickening or the section with the larger diameter pushes an elastic element in the receiving element 18 to the side or deforms it during insertion. After complete insertion, the elastic element relaxes to its original position and is now arranged along the height axis Z above the thickening. This holds the head element 17 in position. Since both the head elements 17 and the receiving elements 18 are made of an electrically conductive material, a particularly simple connection is provided which ensures both a sufficiently mechanically firm connection and an electrical connection between the detector device 3 and the base device 2. In the present case, the head elements 17 are arranged on the first housing 6 and the receiving elements 18 are arranged on the second housing 29 of the base device 3, or are integrated into it. However, a reverse arrangement is also conceivable.

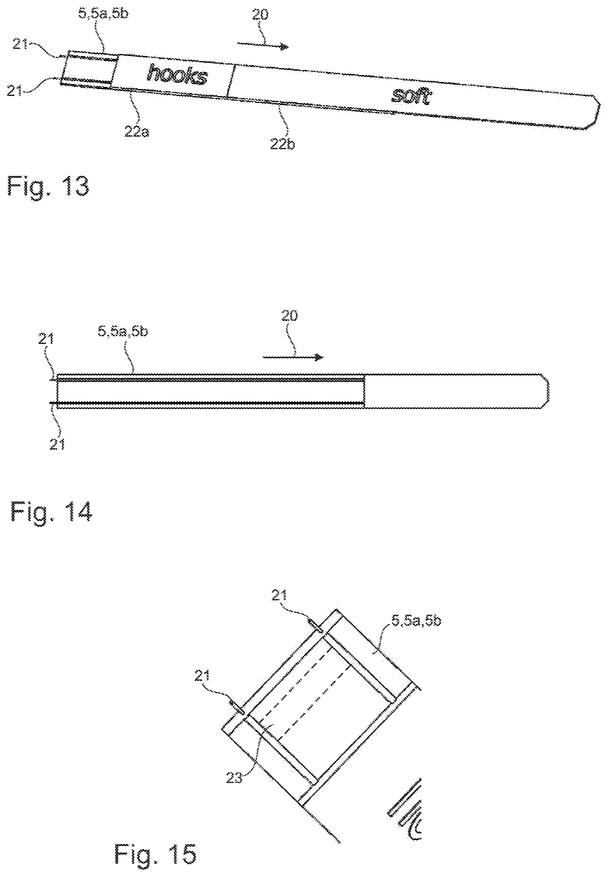

In the present embodiment, the measuring element 5 is designed as a belt element 5a. However, it would also be conceivable to use a clamping element or another fastening element. The belt element 5a serves both as a measuring element 5, on which or with the aid of which the measurement of the electrical parameter is carried out, and as a first fastening means 5b for the sensor device 1, for fastening to a water-bearing element 19. This can, for example, be a hose, a pipe or also a connection for a hose or the like. FIGS. 13 to 15 show such a belt element 5a in detail. Two conducting tracks 21 are integrated in the belt element 5a along its longitudinal extension 20. The belt element 5a is made of a textile material which has a lower conductivity than the conducting tracks 21 and can absorb liquid to a certain degree. The conducting tracks 21 are electrically connected to the two sensing elements 15 so that the electrical parameter is measured in the form of a resistance value between the two conducting tracks 21. In a dry state, a predetermined value is measured. As soon as a leakage occurs, liquid hits the measuring element 5 or the belt element 5a. Since liquids generally have a lower resistance than, for example, a textile material, the measured resistance value between the two conducting tracks 21 decreases due to the influence of the liquid. It should be emphasised that a significant change in the electrical parameter is only caused by a sufficient amount of liquid. Occurring moisture due to condensation will usually not lead to such a significant change of the electrical parameter. This avoids a possibly faulty triggering due to usually unproblematic condensation moisture.

The belt element 5a can be easily and flexibly attached to the water-bearing element 19 by means of a hook and loop fastener. For this purpose, the belt element 5a has two fastening sections 22a, 22b. A first fastening section 22a is provided with barbs or mushroom heads (marked “hooks” in FIG. 13) which engage with the fleece material (marked “soft” in FIG. 13) of the second fastening section 22b and thus create a hook and loop connection.

The belt element 5a or the measuring element 5 belongs to the base device 3. The belt element 5a is guided through a socket 37 of the second housing 29 so that it is mechanically fixed to the belt element 5a. The second housing 29 is designed in such a way that the two receiving elements 18 are connected to the two conducting tracks 21 in an articulated manner. The sensing elements 15 are electrically connected to the conducting tracks 21 by the electrically conductive print head connection.

A standard element 23 can be connected between the conducting tracks 21 or the receiving elements 18, which defines a standard value of the electrical parameter. The standard element 23 is a resistance element. Thus, at least the first frictional and/or positive connection can be checked by measuring the known standard value. The first non-positive and/or positive connection in the form of the push-button connection also represents an electrical connection, as already described. If the push-button connection is complete, the standard resistance value plus a resistance value of the leads can be measured. If the connection is incomplete, on the other hand, a much higher resistance value is present.

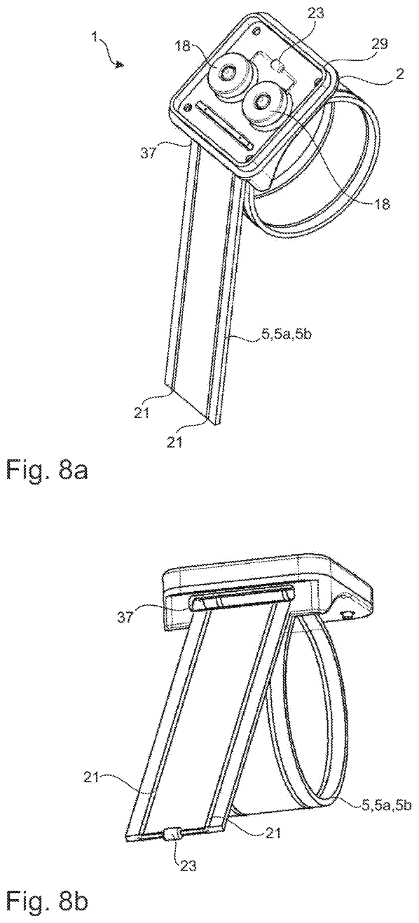

FIG. 8a shows an embodiment in which the standard element 23 is designed as an electrical component. The standard element 23 is connected between the two receiving elements 18. Furthermore, the standard element 23 is arranged within the second housing 29. FIG. 8b shows an embodiment in which the standard element 23 is designed as an electrical component. The standard element 23 is connected between the two conducting tracks 21. Furthermore, the standard element 23 is arranged on the belt element 5a. FIG. 12 also shows a standard element 23 in the form of a resistor element which is connected between the two conducting tracks 21.

As explained above, the belt element 5a may be formed of a first textile material. The resistance element may further be formed as an electrically conductive second textile material in the belt element 5a, which is introduced as a section in the first textile material of the belt element 5a. The conductivity of the second textile material is different from the conductivity of the first textile material. The second textile material thus has the functionality of an electrical component arranged between the conducting tracks 21. This is indicated in FIG. 15. Of course, a combination of the mentioned arrangements of the standard element 23 would also be conceivable.

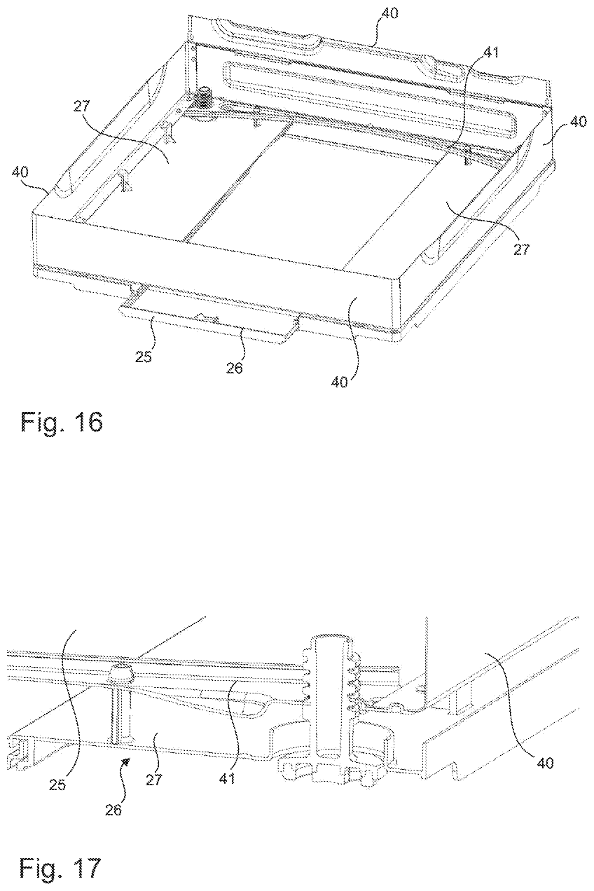

According to a further embodiment, shown in FIGS. 16 to 19 and 21, the base device 2 comprises a receiving element 24 which spatially delimits the measuring chamber 4 at least in sections. The receiving element 24 is suitable and intended for receiving the detector device 3. The receiving element 24 comprises two arm elements 24a, 24b which enclose the detector device 3 in sections and hold it by means of a third non-positive and/or positive connection. The receiving element 24 is thereby arranged on a first section 25 of a liquid collecting device 26. Such a liquid collecting device 26 can be arranged on an underside of the household appliance 100. The first section 25 of the liquid collecting device 26 is plate-shaped and extends along a longitudinal axis Y′ of the household appliance 100. Further, the first section 26 comprises a front end 25a along the longitudinal axis Y′, which is at the front end 26a of the liquid collecting device 26. These front ends 25a, 26a are provided at the front end of the household appliance 100. An end wall 38 extending along the height axis Z′ is provided at this front end 26a. The two arm elements 24a, 24b are arranged on this end wall 38 in such a way that they have a certain elasticity. For insertion and removal of the detector device 3, the two arm elements 24a, 24b can be elastically displaced and/or deformed. The arm elements 24a, 24b thereby engage the first side wall 10b and the side faces 10c, respectively. The polygonal, in particular octagonal, orientation of the side faces 10c ensures a particularly good hold.

According to the present embodiment, the base device 2 thus comprises the first section 25 of the liquid collecting device 26 with the receiving element 24. Advantageously, the detector device 3 can be operated unchanged both with this base device 2 and with the base device 3 described in FIGS. 7 to 12. The base device 2 according to FIGS. 16 to 19 and 21 provides a measuring chamber 4 instead of a measuring element 5, in which the change of the electrical parameter is measured. The measuring chamber 4 is bounded on the underside by the plate-like first section 25 of the liquid collecting device 26. The measuring chamber 4 is bounded on the upper side by the base wall 10a of the first housing element 10. The measuring chamber 4 is bounded on the side by the end wall 38 and the two arm elements 24a, 24b. An opening 43 is provided between the arm elements 24a, 24b through which the leaked liquid can enter the measuring chamber 4. The opening 43 is also necessitated by the possibility of removing the detector direction 3. The sensing elements 15, which, as described, are integrated in the head elements 16, project into the measuring chamber 4. By designing the head elements 16 in the form of the cup-like elements 36, the detector device 3 is sealed with respect to the liquid in the measuring chamber 4. A change in the electrical parameter, in this case a resistance value, is determined as soon as the two sensing elements 15 make contact with the liquid in the measuring chamber 4. Due to the high conductivity of the liquid, a drop in the measured resistance is measured.

The liquid collecting device 26 or only the first section 25 of the liquid collecting device 26 are arranged on the household appliance 100 in such a way that they have a slope along the longitudinal axis Y′ towards the front end 26a, towards the receiving element 24 and/or towards the measuring chamber 4. This means that even a small amount of leaked liquid can be fed to the measuring chamber 4.

The first section 25 of the liquid collecting device 26 is arranged centrally between two outer second sections 27, as can be seen for example in FIG. 16. Furthermore, the liquid collecting device 26 can be moved forward in a drawer-like manner relative to the two outer second sections 27 along a longitudinal direction Y′. For this purpose, a corresponding bearing mechanism 39 is provided on the liquid collecting device 26. The fluid device further comprises four side walls 40 which extend along the height axis Z′ and are connected to the outer second sections 27. Furthermore, two stabilising elements 41 are provided which are connected to the outer second sections 27. The central first section 25 is displaceable under the stabilising elements 41 and the front and rear side walls 40.

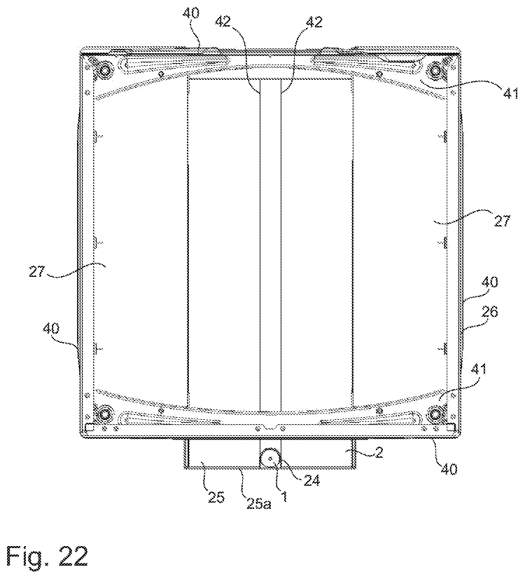

According to a further embodiment as shown in FIG. 22, the base device 2 comprises a receiving element 24 which is arranged on a liquid collecting device 26. This receiving element 24 can be designed analogously to the receiving element 24 according to the embodiment in FIGS. 16 to 19 and 21. The liquid collecting device 26 is provided with at least two conducting tracks 42. In each case, one conducting track 42 is electrically connected to a respective sensing element 15, so that the electrical parameter between the at least two conducting tracks 42 can be measured. The conducting tracks 42 extend along the longitudinal axis Y′ of the liquid collecting device 26. The conducting tracks may extend along the entire length of the liquid collecting device 26 or only along a section of the length of the liquid collecting device 26. The measurement of the electrical parameter may be provided between the conducting tracks 42 and preferably cumulatively additionally in the measuring chamber 4. The conducting tracks 42 may be formed analogously to the embodiment according to FIGS. 7 to 15.

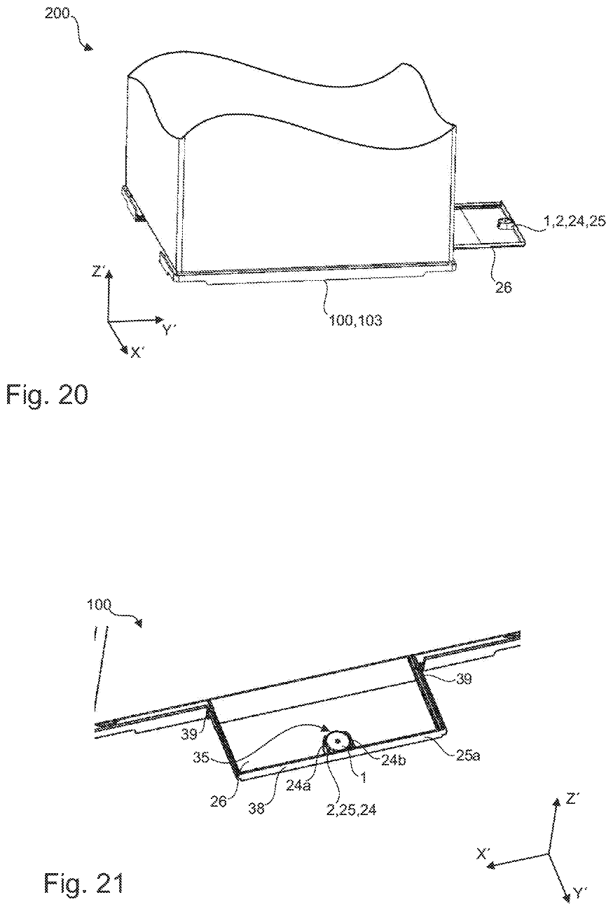

FIG. 20 shows a system 200 comprising a water-bearing household appliance 100 and at least one sensor device 1. The household appliance 100 is only shown in sections. The household appliance 100 may be a dishwasher, a washing machine or any other water-bearing household appliance. The household appliance 100 comprises a housing 103 and a container means provided therein, into which the items to be washed are insertable. The housing 103 of the household appliance 100 is preferably cubic or cuboid in shape. Preferably, the household appliance 100 has at least three side walls. The housing 103 may comprise two lateral side walls. Further, the housing 103 may comprise a rear side wall. Finally, the housing 103 may comprise a front side wall. Furthermore, the household appliance comprises a closure device by means of which the container device can be closed. The closure device may, for example, take the form of a door which is integrated into the front side wall or is provided instead of a front side wall. Operating elements for the user can be provided on the front side wall and/or on the locking device. Such controls are, for example, programme selector switches. The household appliance 100 may further comprise a second communication device 27, which communicates with the communication device 9 of the at least one sensor device 1. Furthermore, a liquid collecting device 26 is arranged on the one underside of the household appliance 100.

The household appliance 100 can have at least one inlet and at least one outlet, which are not shown in FIG. 20. An embodiment with inlets, such as a cold water inlet and a hot water inlet, would be conceivable. This system 200 would therefore comprise a total of six sensor devices 1. The first sensor device 1 would be attached to or near the building connection for the hot water inlet by means of a belt element 5, 5a. The second sensor device 1 would be attached to or near the appliance connection of the household appliance 100 for the hot water supply by means of a belt element 5, 5a. The third sensor device 1 would be attached at or near the building connection for the cold water supply by means of a belt element 5, 5a. The fourth sensor device 1 would be attached to or near the appliance connection of the household appliance 100 for the cold water inlet by means of a belt element 5, 5a. The fifth sensor device 1 would be attached at or near the building connection for the drain by means of a belt element 5, 5a. The sixth sensor device 1 would be mounted in the liquid collecting device 26 by means of a receiving element 24.

Each of the six sensor devices 1 can communicate with the second communication device 44 of the household appliance 100 or another communication device when a leak is detected. An identification message is included in the transmitted message so that the receiver can quickly trace the corresponding sensor device 1 and thus the location of the leakage. The household appliance 100 may comprise a display device for displaying the leakage or the battery level of the sensor devices 1. It is also conceivable that the household appliance 100 sends corresponding messages to a user device, for example a smartphone.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

### LIST OF REFERENCE SIGNS

1 Sensor device
2 Base device
3 Detector device
4 Measuring chamber
5 Measuring element
5a Belt element
5b First fastening means
6 first housing
7 Power supply device or battery
8 Circuit arrangement
9 Communication device
10 First housing element
10a Base wall of the first housing element
10b First side wall
10c Side faces of the first side wall
10d Second side wall
11 Carrier device
11a first side of the carrier device
11b second side of the carrier device
12 Second housing element
12a Base wall of the second housing element
12b Third side wall
13 Web element
14 chamfered elevation
15 Sensing element
16 Spring element
17 Head element
18 Receiving element
19 Water-bearing element
20 Longitudinal extension of the measuring element/belt element
21 Conducting track
22a first fastening section
22b second fastening section
23 Standard element
24 Receiving element
24a, 24b Arm elements
25 first section of the liquid collecting device
25a Front end of the first section
26 Liquid collecting device
26a Front end of the liquid collecting device
27 second section of the liquid collecting device
28 Wireless connection
29 Second housing
30 Protrusion
31 Protrusion
32 Protrusion
33 Upper edge of the second side wall
34 Measuring and comparison device
35 Monitoring device
36 Cup-like element
37 Socket for the second housing
38 End wall
39 Bearing mechanism
40 Side walls
41 Stabilising elements
42 Conducting track
43 Opening
44 Second communication device
100 Household appliance
103 Housing
200 System
U Peripheral direction
Y Longitudinal axis of the sensor device
X Width axis of the sensor device
Z Height axis of the sensor device
Y′ Longitudinal axis of the household appliance
X′ Width axis of the household appliance
Z′ Height axis of the household appliance

What is claimed is:

1. A sensor device for detecting a leakage, in particular for a water-bearing household appliance, wherein
the sensor device comprises a base device and a detector device, wherein the detector device is arranged on the base device by means of at least a first releasable non-positive and/or positive connection,
the detector device detecting a change in an electrical parameter in a measuring chamber and/or a measuring element of the base device, the detector device having a first housing which can be closed in a sealing manner and in which a self-sufficient power supply device and a circuit arrangement are arranged, the circuit arrangement comprising a communication device.

2. The sensor device according to claim 1, wherein
the first housing of the detector device extends along a height axis Z, a width axis X and a longitudinal axis Y, the first housing of the detector device comprising a first housing element which has, at least in sections, a polygonal, in particular an octagonal, base surface, wherein a carrier device with two opposite sides is arranged in the first housing element, wherein the self-sufficient power supply device is arranged on a first side of the carrier device, wherein the circuit arrangement is predominantly arranged on a second side of the carrier device.

3. The sensor device according to claim 2, wherein
the first housing of the detector device comprises a second housing element which is arranged on the first housing element by means of a second non-positive and/or positive connection, the first housing element and the second housing element comprising an opening mechanism for easier release of the second non-positive and/or positive connection, wherein the first housing element comprises at least one web element extending along the height axis Z, wherein the second housing element comprises at least one chamfered elevation, wherein upon rotational movement of the second housing element relative to the first housing element, the at least one chamfered elevation slides along the at least one web element thereby pushing the second housing element away from the first housing element along the height axis Z.

4. The sensor device according to claim 1, wherein
the electrical parameter is an electrical resistance and/or an electrical capacitance, the detector device comprising at least two sensing elements for detecting the electrical parameter, the sensing elements being electrically connected to the circuit arrangement, the at least two sensing elements each being mechanically and electrically connected to the carrier device by means of a spring element.

5. The sensor device according to claim 1, wherein
two first non-positive and/or positive connections are provided between the base device and the detector device, wherein these first non-positive and/or positive connections are snap connections, wherein the first non-positive and/or positive connections each comprise a head element and a receiving element, wherein the head element is detachably fixed in the respective receiving element in the manner of a push button, wherein the head elements are arranged on the detector device and the receiving elements are arranged on the base device or vice versa, wherein the sensing elements are integrated in the head elements or the receiving elements, wherein the head elements and the receiving elements consist of an electrically conductive material.

6. The sensor device according to claim 5, wherein
the base device comprises a second housing, the receiving elements or the head elements being arranged on the second housing.

7. The sensor device according to claim 6, wherein
the measuring element is a belt element or a clamping element, the belt element or the clamping element serving as a first fastening means for the sensor device to a water-bearing element, the belt element or the clamping element being arranged on the second housing.

8. The sensor device according to claim 1, wherein
the base device comprises only the measuring element, wherein the measuring element is a belt element or a clamping element.

9. The sensor device according claim 7, wherein
the belt element or the clamping element comprises at least two conducting tracks along their longitudinal extension, one conducting track in each case being electrically connected to one sensing element in each case, the electrical parameter being given between the at least two conducting tracks, wherein the belt element consists of a textile material which has a lower conductivity than the conducting tracks, wherein the belt element comprises fastening sections by means of which a hook and loop connection can be made.

10. The sensor device according to claim 9, wherein
a standard element is connected between the conducting tracks or between the receiving elements, which standard element predetermines a standard value of the electrical parameter, the standard element being a resistance element, it being possible to check the at least one first non-positive and/or positive connection by measuring the standard value.

11. The sensor device according to claim 1, wherein
the base device comprises a receiving element which spatially delimits the measuring chamber at least in sections and is suitable for and intended to receive the detector device, the receiving element being arranged on a first section of a liquid collecting device which can be arranged on an underside of a household appliance, the receiving element comprising two arm elements which engage in sections around the detector device and hold it by means of a third non-positive and/or positive connection.

12. The sensor device for detecting a leakage, in particular for a water-bearing household appliance, wherein
the sensor device comprises a base device and a detector device, the detector device being arranged on the base device by means of at least one first releasable non-positive and/or positive connection, the detector device detecting a change in an electrical parameter in a measuring element of the base device, the detector device having a first housing which can be closed in a sealed manner and in which a self-sufficient power supply device and a circuit arrangement are arranged, a standard element being provided which specifies a standard value of the electrical parameter, the standard element being a resistance element, it being possible to check the at least one first non-positive and/or positive connection by measuring this standard value.

13. The system comprising a water-bearing household appliance and at least one sensor device according to claim 1.

14. The system according to claim 11, wherein
a liquid collecting device is arranged on
an underside of the household appliance
the liquid collecting device comprising a central first section which is displaceable forwards in a drawer-like manner relative to the two outer second sections along a longitudinal direction Y′.

15. The system according to claim 13, wherein
at least the central first section of the liquid collecting device is arranged on the household appliance in such a way that it has a forward slope along the longitudinal direction Y′ of the household appliance, at least one receiving element with the detector device being arranged at a front end of the first section along the longitudinal direction Y′.
